(19) United States
(12) Patent Application Publication
(10) Pub. No.: US 2023/0278548 A1
(43) Pub. Date: Sep. 7, 2023

(54) LANE-CHANGE PREDICTION DEVICE, LANE-CHANGE PREDICTION METHOD, AND NON-TRANSITORY COMPUTER READABLE RECORDING MEDIUM

(71) Applicant: Mitsubishi Electric Corporation, Tokyo (JP)

(72) Inventors: Taku UMEDA, Tokyo (JP); Takuji MORIMOTO, Tokyo (JP); Kyosuke KONISHI, Tokyo (JP)

(73) Assignee: Mitsubishi Electric Corporation, Tokyo (JP)

(21) Appl. No.: 18/158,529

(22) Filed: Jan. 24, 2023

(30) Foreign Application Priority Data
Mar. 2, 2022 (JP) 2022-031568

(51) Int. Cl. B60W 30/09; B60W 30/095; G08G 1/16

(52) U.S. Cl. CPC B60W 30/09; B60W 30/0953; B60W 30/0956; G08G 1/166; G08G 1/167; B60W 2420/42; B60W 2420/52; B60W 2552/00; B60W 2554/4045

(57) ABSTRACT

A lane-change prediction device includes: a first index calculating unit to calculate a first index that corresponds to a conditional probability of keeping the travel lane of a second vehicle and a conditional probability of changing the travel lane of the second vehicle, on the basis of time-series information related to the travel lane of the second vehicle; a second index calculating unit to calculate a second index related to a travel lane change or deceleration of the second vehicle, on the basis of surrounding vehicle information; and a lane-change prediction unit to calculate a lane change probability that the second vehicle changes the travel lane, on the basis of the first index and the second index.

### TECHNICAL FIELD

The present disclosure relates to a lane-change prediction device, a lane-change prediction method, and a program.

### BACKGROUND ART

Conventionally, there has been proposed a technique of predicting a cut-in to a traveling lane of a host vehicle by a vehicle traveling in a lane adjacent to the lane of the host vehicle. For example, the lane-change estimation device described in Patent Literature 1 derives, for a plurality of sets of two vehicles, a first index value based on a relationship related to a traveling direction between two vehicles among a host vehicle, a first vehicle, a second vehicle, and a third vehicle on the basis of a situation around the host vehicle. Then, the lane-change estimation device estimates the possibility that the third vehicle changes the lane on the basis of the first index value and the position of the third vehicle in a lateral direction.

### CITATION LIST

### Patent Literatures

Patent Literature 1: Japanese Patent No. 6494121

### SUMMARY OF INVENTION

### Technical Problem

The conventional lane-change prediction device predicts the lane change of a target vehicle detected around a host vehicle on the basis of a relationship with the target vehicle. The device described in Patent Literature 1 derives the index value based on a relationship related to a traveling direction (a speed, a position, and the like) between vehicles on the basis of a situation around the host vehicle, and predicts the lane change of the target vehicle using the derived index value. Therefore, the conventional lane-change prediction device has a problem that unless there is a relationship in which the target vehicle can be predicted to change the lane, even if the driver of the target vehicle has an action intention to change the lane, the lane change of the target vehicle may not be predicted.

For example, in a case where the host vehicle is traveling in a lane leading to a junction and the target vehicle is changing the lane from behind the host vehicle toward the junction, it seems that the driver of the target vehicle has an action intention to change the lane and move in front of the host vehicle in order to proceed to the junction. In addition, in a case where there is a target vehicle traveling in a passing lane behind the host vehicle, it seems that the driver of the target vehicle has an action intention to overtake the host vehicle and then change the lane and move in front of the host vehicle. However, in the conventional technique, unless the target vehicle and the host vehicle have a relationship in which a lane change can be predicted, even if the driver of the target vehicle has an action intention to change the lane, the lane change is not predicted.

The present disclosure solves the above problem, and an object of the present disclosure is to obtain a lane-change prediction device, a lane-change prediction method, and a program capable of performing lane change prediction in consideration of an action intention of a driver.

### Solution to Problem

A lane-change prediction device according to the present disclosure includes: processing circuitry to calculate, by using road information related to a road on which a first vehicle travels and surrounding vehicle information related to at least one second vehicle present around the first vehicle, travel lane information indicating a travel lane of the second vehicle; to store, for each of the at least one second vehicle, the travel lane information; to calculate a first index that corresponds to a conditional probability of keeping the travel lane of the second vehicle and a conditional probability of changing the travel lane of the second vehicle, on a basis of time-series information related to the travel lane of the second vehicle, the time-series information being indicated by the travel lane information stored; to calculate a second index related to a travel lane change or deceleration of the second vehicle, on the basis of the surrounding vehicle information; and to calculate a lane change probability that the second vehicle changes the travel lane, on the basis of the first index and the second index.

### Advantageous Effects of Invention

According to the present disclosure, the first index that corresponds to the conditional probability of keeping the travel lane of the second vehicle and the conditional probability of changing the travel lane of the second vehicle is calculated on the basis of the time-series information related to the travel lane of the second vehicle, the second index related to the travel lane change or deceleration of the second vehicle is calculated on the basis of the surrounding vehicle information, and the lane change probability that the second vehicle changes the travel lane is calculated on the basis of the first index and the second index. The time-series information related to the travel lane of the second vehicle is information indicating a travel path reflecting the action intention of the driver of the second vehicle from the past to the present. As a result, the first index reflecting the action intention of the driver of the second vehicle from the past to the present can be calculated by using the time-series information related to the travel lane of the second vehicle. The lane-change prediction device according to the present disclosure can perform lane change prediction in consideration of the action intention of the driver of the vehicle by using the first index reflecting the action intention of the driver of the second vehicle.

### BRIEF DESCRIPTION OF DRAWINGS

FIG. 1 is a block diagram illustrating a configuration of a lane-change prediction device according to a first embodiment.

FIGS. 2A, 2B, and 2C are schematic diagrams illustrating the outline of a lane change.

FIGS. 3A and 3B are schematic diagrams illustrating the outline of generation of imaginary paths.

FIG. 4 is a schematic diagram illustrating the outline of a process of calculating a lane change probability.

FIG. 5 is a flowchart illustrating a lane-change prediction method according to the first embodiment.

FIGS. 6A and 6B are block diagrams each illustrating a hardware configuration that implements functions of the lane-change prediction device according to the first embodiment.

FIG. 7 is a block diagram illustrating a configuration of a lane-change prediction device according to a second embodiment.

FIG. 8 is a block diagram illustrating a configuration of a first index calculating unit included in the lane-change prediction device according to the second embodiment.

FIG. 9 is a flowchart illustrating a lane-change prediction method according to the second embodiment.

FIG. 10 is a block diagram illustrating a configuration of a lane-change prediction device according to a third embodiment.

FIG. 11 is a flowchart illustrating a lane-change prediction method according to the third embodiment.

### DESCRIPTION OF EMBODIMENTS

### First Embodiment

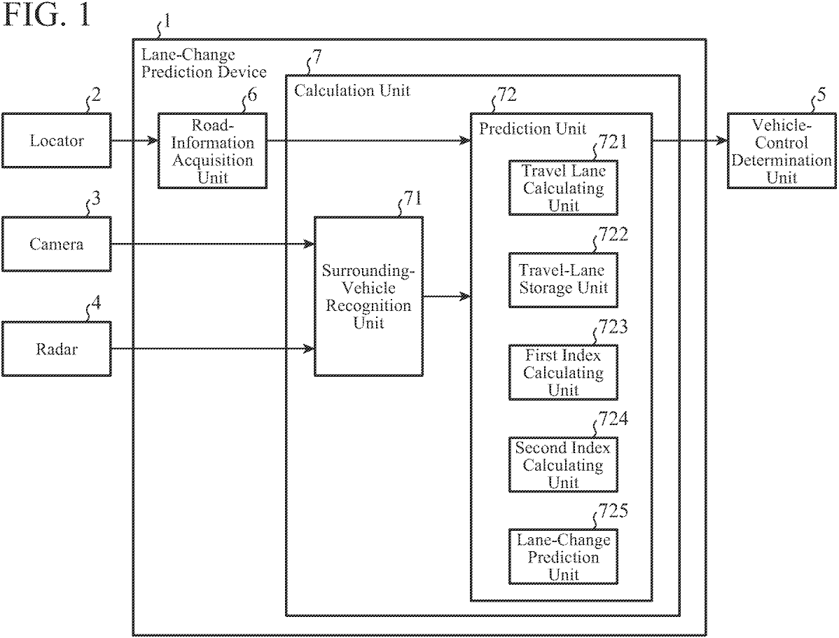

FIG. 1 is a block diagram illustrating a configuration of a lane-change prediction device 1 according to a first embodiment. In FIG. 1, the lane-change prediction device 1 is provided in a first vehicle and predicts the lane change of one or a plurality of second vehicles traveling around the first vehicle. A locator 2, a camera 3, and a radar 4 are mounted on the first vehicle, and a vehicle-control determination unit 5 is one of functions of an electronic control unit (ECU) included in the first vehicle. Note that the lane-change prediction device 1 may be mounted on the first vehicle, or may be implemented as a function of a server capable of wirelessly communicating with the locator 2, the camera 3, the radar 4, and the vehicle-control determination unit 5 mounted on the first vehicle.

The lane-change prediction device 1 calculates a first index based on the travel lane of the second vehicle from the past to the present and a second index related to the travel lane change or the deceleration of the second vehicle using detection information of each of the locator 2, the camera 3, and the radar 4, and predicts the lane change of the second vehicle using the first index and the second index. The vehicle-control determination unit 5 determines the content of the driving control on the first vehicle on the basis of lane-change prediction information on the second vehicle.

The locator 2 detects position information of the first vehicle. For example, the locator 2 detects the position information of the first vehicle using a GPS sensor, and acquires road information corresponding to the detected position information of the first vehicle from a road information database (not illustrated) in which road information is registered. The road information includes the shape of a road, the number of lanes, the width of the lane in which the first vehicle is traveling, and the like.

The camera 3 is an out-of-vehicle camera that captures the surroundings of the first vehicle. For example, the camera 3 captures the second vehicle traveling around the first vehicle. The radar 4 is a device that detects a distance to an object present around the first vehicle, a velocity of the object, and an orientation of the object. As the radar 4, for example, a millimeter wave radar is used.

The lane-change prediction device 1 includes a road-information acquisition unit 6 and a calculation unit 7. The locator 2 outputs road information corresponding to the position information of the first vehicle to the road-information acquisition unit 6. The road-information acquisition unit 6 acquires the road information corresponding to the position information of the first vehicle output by the locator 2. The calculation unit 7 predicts the lane change of the second vehicle using detection information of each of the locator 2, the camera 3, and the radar 4. The calculation unit 7 includes a surrounding-vehicle recognition unit 71 and a prediction unit 72.

The surrounding-vehicle recognition unit 71 recognizes the second vehicle that is present around the first vehicle by using video information captured by the camera 3 and object information detected by the radar 4. For example, the surrounding-vehicle recognition unit 71 calculates the distance from the first vehicle to the second vehicle on the basis of the vehicle type and position information of the second vehicle determined by performing an image analysis on frame images of the video captured by the camera 3 and distance information of the second vehicle detected by the radar 4. Furthermore, the surrounding-vehicle recognition unit 71 calculates the relative speed and the relative acceleration of the second vehicle with respect to the first vehicle by analyzing a temporal change in the distance information of the second vehicle.

Surrounding vehicle information including the position information, the relative speed, the relative acceleration, and the vehicle type of the second vehicle calculated by the surrounding-vehicle recognition unit 71 is output to the prediction unit 72. Note that the surrounding vehicle information may include reliability indicating detection accuracy of the second vehicle. The reliability is a probability that a detection value included in the surrounding vehicle information is included in a reliability section. For example, if the reliability is 95%, the detection value is 95% reliable.

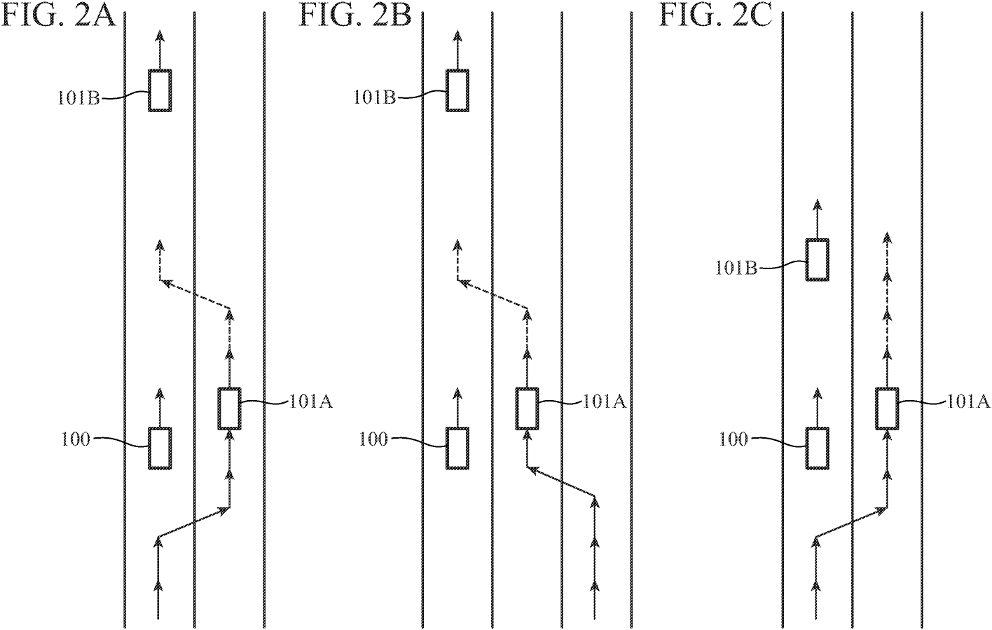

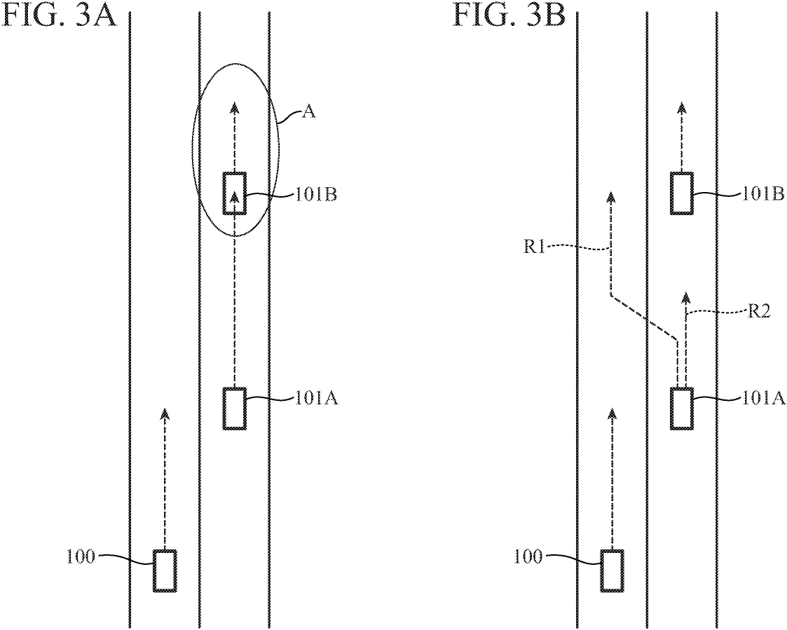

The prediction unit 72 predicts the lane change of one or a plurality of second vehicles traveling around the first vehicle, and outputs lane-change prediction information on the second vehicle to the vehicle-control determination unit 5. FIGS. 2A, 2B, and 2C are schematic diagrams illustrating the outline of the lane change, and illustrate modes in which a second vehicle 101A and a second vehicle 101B are traveling around a first vehicle 100 and the second vehicle 101A changes the lane. In FIGS. 2A, 2B, and 2C, the second vehicle 101A is a target vehicle of lane change prediction. A solid arrow indicates a path on which the second vehicle 101A has actually traveled, and a dashed arrow indicates a predicted path on which the second vehicle 101A is expected to travel in the future.

In FIG. 2A, the first vehicle 100, the second vehicle 101A, and the second vehicle 101B are traveling on a two-lane road, and the second vehicle 101A that has been traveling in the same lane as the first vehicle 100 changes to the adjacent lane behind the first vehicle 100 and is traveling diagonally in front of the first vehicle 100 in the changed lane. It thus seems that the driver of the second vehicle 101A has an action intention to “overtake the first vehicle 100”. On the other hand, it is assumed that the second vehicle 101B is traveling in front of the first vehicle 100, and a distance necessary for the second vehicle 101A to change the lane and move in front of the first vehicle 100 is provided between the first vehicle 100 and the second vehicle 101B.

The prediction unit 72 calculates a first index reflecting the action intention of the driver of the second vehicle 101A to “overtake the first vehicle 100” on the basis of time-series information on the travel lane indicated by the solid arrow. Furthermore, the prediction unit 72 calculates a second index related to the travel lane change or the deceleration of the second vehicle 101A, the second index being based on the current positional relationship among the vehicles, by using information indicating the position and speed of each of the first vehicle 100, the second vehicle 101A, and the second vehicle 101B. A distance necessary for the second vehicle 101A to change the lane and move in front of the first vehicle 100 is provided between the first vehicle 100 and the second vehicle 101B. Therefore, the prediction unit 72 predicts that the second vehicle 101A changes the lane along the path indicated by the dashed arrow on the basis of the first index reflecting the action intention of the driver of the second vehicle 101A instead of the second index, and outputs lane-change prediction information on the second vehicle 101A to the vehicle-control determination unit 5.

In FIG. 2B, it is assumed that the first vehicle 100, the second vehicle 101A, and the second vehicle 101B are traveling on a three-lane road, and there is a junction ahead of the travel lane of the first vehicle 100. The second vehicle 101A that has been traveling in the lane farthest from the travel lane of the first vehicle 100 changes to the adjacent lane behind the first vehicle 100 and is traveling diagonally in front of the first vehicle 100 in the changed lane. It thus seems that the driver of the second vehicle 101A has an action intention to “overtake the first vehicle 100 and proceed to the junction”. On the other hand, it is assumed that the second vehicle 101B is traveling in front of the first vehicle 100, and a distance necessary for the second vehicle 101A to change the lane and move in front of the first vehicle 100 is provided between the first vehicle 100 and the second vehicle 101B.

The prediction unit 72 calculates a first index reflecting the action intention of the driver of the second vehicle 101A to “overtake the first vehicle 100 and proceed to the junction” on the basis of time-series information on the travel lane indicated by the solid arrow. Furthermore, the prediction unit 72 calculates a second index related to the travel lane change or the deceleration of the second vehicle 101A, the second index being based on the positional relationship among the vehicles, by using information indicating the position and speed of each of the first vehicle 100, the second vehicle 101A, and the second vehicle 101B. A distance necessary for the second vehicle 101A to change the lane and move in front of the first vehicle 100 is provided between the first vehicle 100 and the second vehicle 101B. Therefore, the prediction unit 72 predicts that the second vehicle 101A changes the lane along the path indicated by the dashed arrow on the basis of the first index reflecting the action intention of the driver of the second vehicle 101A instead of the second index, and outputs lane-change prediction information on the second vehicle 101A to the vehicle-control determination unit 5.

In FIG. 2C, the first vehicle 100, the second vehicle 101A, and the second vehicle 101B are traveling on a two-lane road. The second vehicle 101A has changed to the adjacent lane behind the first vehicle 100 and is traveling diagonally in front of the first vehicle 100 in the changed lane. The second vehicle 101B is traveling in front of the first vehicle 100. In this case, it seems that the driver of the second vehicle 101A has an action intention to “overtake the first vehicle 100”, but the inter-vehicle distance between the first vehicle 100 and the second vehicle 101B prevents the second vehicle 101A from changing to the travel lane of the first vehicle 100.

The prediction unit 72 calculates a first index reflecting the action intention of the driver of the second vehicle 101A to “overtake the first vehicle 100” on the basis of time-series information on the travel lane indicated by the solid arrow. Furthermore, the prediction unit 72 calculates a second index related to the travel lane change or the deceleration of the second vehicle 101A, the second index being based on the positional relationship among the vehicles, by using information indicating the position and speed of each of the first vehicle 100, the second vehicle 101A, and the second vehicle 101B.

There is no distance necessary for the second vehicle 101A to change the lane and move in front of the first vehicle 100 between the first vehicle 100 and the second vehicle 101B. Therefore, the prediction unit 72 predicts that the second vehicle 101A does not change the lane as indicated by the dashed arrow on the basis of the second index reflecting the current positional relationship among the first vehicle 100, the second vehicle 101A, and the second vehicle 101B instead of the first index, and outputs lane-change prediction information on the second vehicle 101A to the vehicle-control determination unit 5. As described above, the lane-change prediction information may include a prediction result that the target vehicle does not change the lane. In the following description, the second vehicle present around the first vehicle 100 will be collectively referred to as “second vehicle 101” as appropriate.

As illustrated in FIG. 1, the prediction unit 72 includes a travel lane calculating unit 721, a travel-lane storage unit 722, a first index calculating unit 723, a second index calculating unit 724, and a lane-change prediction unit 725. The travel lane calculating unit 721 calculates travel lane information indicating a travel lane of the second vehicle 101, by using surrounding vehicle information related to the second vehicle 101 present around the first vehicle 100 and road information related to a road on which the first vehicle 100 travels.

For example, the travel lane calculating unit 721 determines that, among a plurality of lanes on the travel road of the first vehicle 100 indicated by the road information, the lane closest to the position of the second vehicle 101 indicated by the surrounding vehicle information is the travel lane of the second vehicle 101, and calculates the travel lane information related to the travel lane of the second vehicle 101. Furthermore, the travel lane calculating unit 721 determines that, among the lanes on the travel road of the first vehicle 100 indicated by the road information, the lane closest to the position of the first vehicle 100 is the travel lane of the first vehicle 100, and calculates the travel lane information related to the travel lane of the first vehicle 100.

The travel-lane storage unit 722 stores the travel lane information calculated by the travel lane calculating unit 721 for each second vehicle 101. For example, when the second vehicle 101 is recognized around the first vehicle 100, the travel lane calculating unit 721 determines the travel lane of the second vehicle 101, and calculates the travel lane information related to the determined travel lane. The travel-lane storage unit 722 sequentially stores the travel lane information of the second vehicle 101 calculated by the travel lane calculating unit 721.

For example, the travel-lane storage unit 722 stores all the travel lane information of the second vehicle 101 calculated by the travel lane calculating unit 721 during the period from the time when the second vehicle 101 is recognized for the first time to the current time. In a case where the second vehicle 101 is recognized for the first time thirty seconds before the present, the travel-lane storage unit 722 stores only the travel lane information which is obtained for thirty seconds before the present, and erases the travel lane information which is obtained before the period from thirty seconds ago to the present.

The first index calculating unit 723 calculates a first index that corresponds to a conditional probability of keeping the travel lane of the second vehicle 101 and a conditional probability of changing the travel lane of the second vehicle 101, on the basis of time-series information related to the travel lane of the second vehicle 101, the time-series information being indicated by the travel lane information stored in the travel-lane storage unit 722. For example, the first index calculating unit 723 acquires a travel lane sequence of the second vehicle 101 in a preset period from the past to the present, the travel lane sequence being indicated by the travel lane information stored in the travel-lane storage unit 722. Then, the first index calculating unit 723 calculates the first index using the acquired travel lane sequence. As a result, the first index calculating unit 723 can calculate, as the first index, an index value reflecting the action intention of the driver of the second vehicle 101 from the past to the present.

The first index corresponds to a conditional probability of keeping the travel lane of the second vehicle 101 and a conditional probability of changing the travel lane of the second vehicle 101, the probabilities being calculated on the basis of the travel lane sequence in the preset period from the past to the present. The first index calculating unit 723 calculates the conditional probability of keeping the lane and the conditional probability of changing the lane by using information as to how many times and at which timing the second vehicle 101 has changed to the right or left lane, the information being included in the travel lane sequence.

For example, the tendency of a travel lane sequence is experimentally obtained which shows what type of a lane change performed by a certain vehicle causes the vehicle to perform a certain type of a lane change next. Furthermore, a generation rule is prepared in advance which is for generating the first index and which corresponds to the tendency of the travel lane sequence. The first index calculating unit 723 calculates the first index related to the second vehicle 101 by using the travel lane sequence of the second vehicle obtained from the past to the present and the rule for generating the first index. For example, the probability of occurrence of the lane change of the second vehicle 101 and the probability of keeping the lane of the second vehicle 101 after several seconds are calculated as the first index.

For example, in a case where the travel lane sequence of the second vehicle 101 includes a travel lane sequence indicating a lane change from a cruising lane to a passing lane and the second vehicle 101 is currently traveling in the passing lane, the first index calculating unit 723 calculates the first index by using a generation rule that makes the probability of a lane change in which the second vehicle 101 returns to the cruising lane higher than the probability of keeping the travel lane. Further, in a case where the travel lane sequence of the second vehicle 101 does not include a lane change, the first index calculating unit 723 calculates the first index by using a generation rule that makes the probability of keeping the travel lane higher than the probability of a lane change.

When the travel lane sequence of the second vehicle 101 is input to the first index calculating unit 723, the first index calculating unit 723 may calculate the first index by using a learning model that outputs the first index. For example, the first index calculating unit 723 calculates the first index that corresponds to a conditional probability of changing the lane of the second vehicle 101 and a conditional probability of keeping the lane of the second vehicle 101 by using the hidden Markov model. The parameters of the hidden Markov model are estimated in advance by using travel lane sequence data of the second vehicle 101 as learning data. When the travel lane sequence of the second vehicle 101 is input to the hidden Markov model, the hidden Markov model outputs, as the first index, the conditional probability of changing the lane of the second vehicle 101 and the conditional probability of keeping the lane of the second vehicle 101.

The second index calculating unit 724 calculates a second index related to the travel lane change or the deceleration of the second vehicle 101 on the basis of surrounding vehicle information. For example, in a case where assuming that the second vehicle 101 indicated by the surrounding vehicle information keeps the current driving behavior, there is a possibility of collision with the first vehicle 100 or collision between the second vehicles 101, the second index calculating unit 724 generates an imaginary path on which the second vehicle 101 changes the travel lane in order to avoid collision and an imaginary path on which the second vehicle 101 decelerates in order to avoid collision. Then, the second index calculating unit 724 calculates the second index on the assumption that the second vehicle 101 travels on each of these imaginary paths. As a result, the second index calculating unit 724 can calculate, as the second index, an index value corresponding to each of the positional relationship between the first vehicle 100 and the second vehicle 101 and the current positional relationship between different second vehicles 101.

FIGS. 3A and 3B are schematic diagrams illustrating the outline of generation of imaginary paths, and illustrate modes of the imaginary paths of the second vehicle 101A used when the second vehicle 101A and the second vehicle 101B are present around the first vehicle 100 and the second index of the second vehicle 101A is calculated. In FIGS. 3A and 3B, the first vehicle 100, the second vehicle 101A, and the second vehicle 101B are traveling on a two-lane road. The second vehicle 101A is a target vehicle of lane change prediction.

By using the surrounding vehicle information, the second index calculating unit 724 determines that there is a possibility of collision with the second vehicle 101B present within the area indicated by the reference sign A in FIG. 3A when the second vehicle 101A traveling in the lane adjacent to the travel lane of the first vehicle 100 travels from the current position while keeping the current speed. In this case, as illustrated in FIG. 3B, the second index calculating unit 724 generates an imaginary path R1 on which the second vehicle 101A changes the travel lane in order to avoid the collision of the second vehicle 101A with the second vehicle 101B and an imaginary path R2 on which the second vehicle 101A decelerates in order to avoid the collision.

For example, by using the surrounding vehicle information, the second index calculating unit 724 calculates the imaginary path R1 on which the second vehicle 101A changes the lane and then calculates an imaginary path that is possibly taken by the second vehicle 101B with the highest probability. Next, the second index calculating unit 724 compares these imaginary paths to calculate a distance D1 at which the second vehicle 101A and the second vehicle 101B come closest to each other.

Similarly, by using the surrounding vehicle information, the second index calculating unit 724 calculates the imaginary path R2 on which the second vehicle 101A decelerates and then calculates an imaginary path that is possibly taken by the second vehicle 101B with the highest probability. Next, the second index calculating unit 724 compares these imaginary paths to calculate a distance D2 at which the second vehicle 101A and the second vehicle 101B come closest to each other.

The second index calculating unit 724 calculates the second index on the assumption that the second vehicle 101A travels on each of the imaginary path R1 and the imaginary path R2. For example, the second index calculating unit 724 calculates a lane change probability P1 that the second vehicle 101A changes the lane on the basis of the following expression (1), and also calculates a deceleration probability P2 that the second vehicle 101A decelerates on the basis of the following expression (2). The lane change probability P1 and the deceleration probability P2 correspond to the second index. Note that the sum of the lane change probability P1 and the deceleration probability P2 is one.

$$\text{Lane change probability P1 = D1/(D1 + D2)} \qquad \text{(1)}$$

$$\text{Deceleration probability P2 = D2/(D1 + D2)} \qquad \text{(2)}$$

The lane-change prediction unit 725 calculates a lane change probability that the second vehicle 101 changes the travel lane on the basis of the first index and the second index. For example, the lane-change prediction unit 725 calculates a weighted average of the first index and the second index at a preset ratio. The lane-change prediction unit 725 changes the weight of the first index and the weight of the second index in the weighted average to calculate the lane change probability. As a result, the lane-change prediction unit 725 can calculate the lane change probability in which the first index and the second index are reflected at a desired ratio.

For example, the first index calculating unit 723 acquires a travel lane sequence of the second vehicle 101 in a preset period from the past to the present, the travel lane sequence being indicated by the travel lane information stored in the travel-lane storage unit 722. Then, the first index calculating unit 723 calculates the first index using the acquired travel lane sequence. The lane-change prediction unit 725 changes the weight of the first index in the weighted average depending on the length of the travel lane sequence used for calculating the first index.

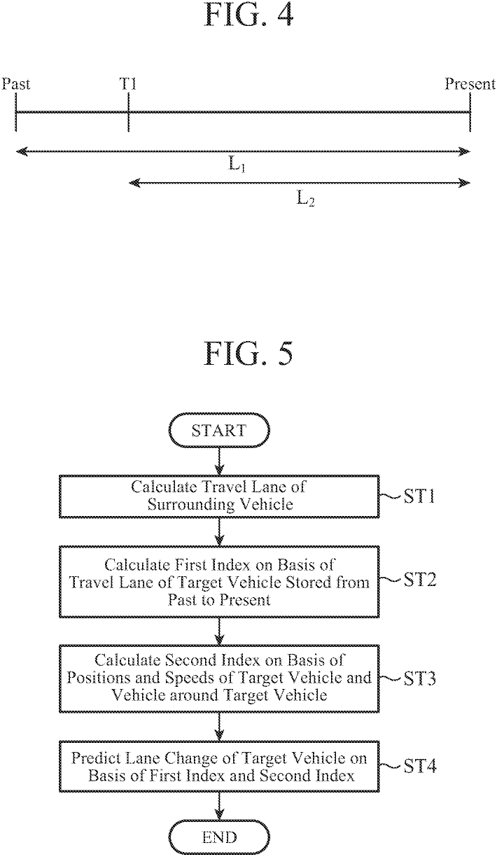

FIG. 4 is a schematic diagram illustrating the outline of a process of calculating a lane change probability. The timeline illustrated in FIG. 4 is a period which is set from the past to the present. The first index calculating unit 723 calculates the first index by using the travel lane sequence of the second vehicle 101. For example, in a case where the second vehicle 101 is recognized at time T1 in the timeline illustrated in FIG. 4, the first index calculating unit 723 acquires the travel lane sequence of the second vehicle 101 in a period from the time T1 to the present, and calculates the first index using the travel lane sequence.

The lane-change prediction unit 725 changes the weight of the first index in the weighted average depending on the time length of the travel lane sequence used for calculating the first index. For example, in a case where the time length of the preset period from the past to the present is L₁, the time length of the travel lane sequence of the second vehicle 101 is L₂, and L₂ is shorter than L₁ as illustrated in FIG. 4, the lane-change prediction unit 725 reduces the weight of the first index. For example, the ratio L₂/L₁ is defined as the weight of the first index. A value obtained by adding the probability corresponding to the first index and the probability corresponding to the second index is one. The lane-change prediction unit 725 calculates, as a final lane change probability, a probability obtained by weighted-averaging the probability corresponding to the first index and the probability corresponding to the second index.

FIG. 5 is a flowchart illustrating a lane-change prediction method according to the first embodiment, and illustrates an operation of the prediction unit 72. The travel lane calculating unit 721 calculates travel lane information indicating the travel lane of the second vehicle 101 by using the surrounding vehicle information related to the second vehicle 101 present around the first vehicle 100 and the road information related to a road on which the first vehicle 100 travels, and stores the travel lane information in the travel-lane storage unit 722 for each second vehicle 101 (step ST1).

The first index calculating unit 723 calculates the first index that corresponds to the conditional probability of keeping the travel lane of the second vehicle 101 and the conditional probability of changing the travel lane of the second vehicle 101, on the basis of the travel lane sequence of the second vehicle 101 indicated by the travel lane information stored in the travel-lane storage unit 722 (step ST2). For example, in a case where the travel lane sequence of the second vehicle 101 includes the lane change of the second vehicle 101 to a passing lane and the second vehicle 101 is currently traveling in the passing lane, the first index is an index in which the probability that the second vehicle 101 returns to a cruising lane (changes the lane) is increased. By using the first index, the lane-change prediction device 1 can predict a lane change for the second vehicle 101 to return to the original cruising lane after overtaking the first vehicle 100 using the passing lane.

Furthermore, in a case where the travel lane sequence of the second vehicle 101 does not include a lane change, the first index is an index in which the probability that the second vehicle 101 does not change the lane is increased. By using the first index, the lane-change prediction device 1 can predict the action intention of the driver of the second vehicle 101 to keep a specific lane.

The second index calculating unit 724 calculates the second index related to the travel lane change or the deceleration of the second vehicle 101 on the basis of the surrounding vehicle information (step ST3). For example, the second index is an index in which the probability of traveling on an imaginary path with a low possibility of collision with another vehicle among a plurality of possible imaginary paths for the second vehicle 101 is increased. By using the second index, the lane-change prediction device 1 can easily select the path with a low possibility of collision with another vehicle.

Note that the order of the first index calculating process in step ST2 and the second index calculating process in step ST3 is not limited to this order. For example, the first index calculating process and the second index calculating process may be switched, or these processes may be performed simultaneously.

The lane-change prediction unit 725 calculates the lane change probability that the second vehicle 101 changes the travel lane on the basis of the first index and the second index (step ST4). As a result, the lane-change prediction device 1 can predict a lane change with a low possibility of collision with another vehicle while considering the action intention of the driver of the second vehicle 101.

Next, a hardware configuration that implements the functions of the lane-change prediction device 1 will be described.

The functions of the travel lane calculating unit 721, the travel-lane storage unit 722, the first index calculating unit 723, the second index calculating unit 724, and the lane-change prediction unit 725 included in the lane-change prediction device 1 are implemented by a processing circuit. That is, the lane-change prediction device 1 includes a processing circuit for performing the processes from step ST1 to step ST4 illustrated in FIG. 5. The processing circuit may be dedicated hardware, or may be a central processing unit (CPU) that executes a program stored in a memory.

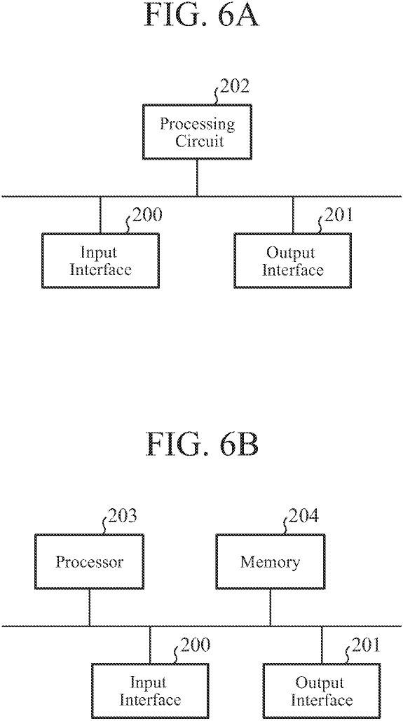

FIG. 6A is a block diagram illustrating the hardware configuration that implements the functions of the lane-change prediction device 1. FIG. 6B is a block diagram illustrating a hardware configuration that executes software that implements the functions of the lane-change prediction device 1. In FIGS. 6A and 6B, an input interface 200 relays information input by the lane-change prediction device 1 from the locator 2, the camera 3, and the radar 4, and is an interface that implements information acquisition functions of the road-information acquisition unit 6 and the surrounding-vehicle recognition unit 71. An output interface 201 is an interface that relays information output from the lane-change prediction device 1 to the vehicle-control determination unit 5.

In a case where the processing circuit is a processing circuit 202 of dedicated hardware illustrated in FIG. 6A, the processing circuit 202 corresponds to, for example, a single circuit, a composite circuit, a programmed processor, a parallel programmed processor, an application specific integrated circuit (ASIC), a field-programmable gate array (FPGA), or a combination thereof. The functions of the travel lane calculating unit 721, the travel-lane storage unit 722, the first index calculating unit 723, the second index calculating unit 724, and the lane-change prediction unit 725 included in the lane-change prediction device 1 may be implemented by two or more processing circuits, or these functions may be collectively implemented by one processing circuit.

In a case where the processing circuit is a processor 203 illustrated in FIG. 6B, the functions of the travel lane calculating unit 721, the travel-lane storage unit 722, the first index calculating unit 723, the second index calculating unit 724, and the lane-change prediction unit 725 included in the lane-change prediction device 1 are implemented by software, firmware, or a combination of software and firmware. The software or firmware is described as a program and stored in a memory 204.

The processor 203 implements the functions of the travel lane calculating unit 721, the travel-lane storage unit 722, the first index calculating unit 723, the second index calculating unit 724, and the lane-change prediction unit 725 included in the lane-change prediction device 1 by reading and executing the program stored in the memory 204. For example, the lane-change prediction device 1 includes the memory 204 for storing a program that allows the processes from step ST1 to step ST4 illustrated in FIG. 5 to be performed when executed by the processor 203.

These programs cause a computer to perform procedures or methods of the processes performed by the travel lane calculating unit 721, the travel-lane storage unit 722, the first index calculating unit 723, the second index calculating unit 724, and the lane-change prediction unit 725. The memory 204 may be a computer readable recording medium that stores a program for causing a computer to function as the travel lane calculating unit 721, the travel-lane storage unit 722, the first index calculating unit 723, the second index calculating unit 724, and the lane-change prediction unit 725.

The memory 204 corresponds to, for example, a nonvolatile or volatile semiconductor memory such as a random access memory (RAM), a read only memory (ROM), a flash memory, an erasable programmable read only memory (EPROM), or an electrically-EPROM (EEPROM), a magnetic disk, a flexible disk, an optical disk, a compact disk, a mini disk, a DVD, or the like.

A part of the functions of the travel lane calculating unit 721, the travel-lane storage unit 722, the first index calculating unit 723, the second index calculating unit 724, and the lane-change prediction unit 725 included in the lane-change prediction device 1 may be implemented by dedicated hardware, and another part thereof may be implemented by software or firmware. For example, the function of the travel-lane storage unit 722 is implemented by the processing circuit 202 that is dedicated hardware, and the functions of the travel lane calculating unit 721, the first index calculating unit 723, the second index calculating unit 724, and the lane-change prediction unit 725 are implemented by the processor 203 reading and executing the program stored in the memory 204. As described above, the processing circuit can implement the functions by hardware, software, firmware, or a combination thereof.

As described above, the lane-change prediction device 1 according to the first embodiment includes: the travel lane calculating unit 721 that calculates the travel lane information indicating the travel lane of the second vehicle 101 present around the first vehicle 100, by using the surrounding vehicle information and the road information; the travel-lane storage unit 722 that stores the travel lane information for each second vehicle 101; the first index calculating unit 723 that calculates the first index that corresponds to the conditional probability of keeping the travel lane of the second vehicle 101 and the conditional probability of changing the travel lane of the second vehicle 101, on the basis of the time-series information related to the travel lane of the second vehicle 101, the time-series information being indicated by the travel lane information stored in the travel-lane storage unit 722; the second index calculating unit 724 that calculates the second index related to the travel lane change or the deceleration of the second vehicle 101 on the basis of the surrounding vehicle information; and the lane-change prediction unit 725 that calculates the lane change probability that the second vehicle 101 changes the travel lane, on the basis of the first index and the second index. The time-series information related to the travel lane of the second vehicle 101 is information indicating a travel path reflecting the action intention of the driver of the second vehicle 101 from the past to the present. As a result, the first index reflecting the action intention of the driver of the second vehicle 101 from the past to the present can be calculated by using the time-series information related to the travel lane of the second vehicle 101. The lane-change prediction device 1 can perform lane change prediction in consideration of the action intention of the driver of the second vehicle 101 by using the first index reflecting the action intention of the driver of the second vehicle 101.

In the lane-change prediction device 1 according to the first embodiment, the first index calculating unit 723 acquires a travel lane sequence of the second vehicle 101 in a preset period from the past to the present, and calculates the first index using the travel lane sequence, the travel lane sequence being indicated by the travel lane information stored in the travel-lane storage unit 722. As a result, the first index calculating unit 723 can calculate, as the first index, an index value reflecting the action intention of the driver of the second vehicle 101 from the past to the present.

In a case where assuming that the second vehicle 101 indicated by the surrounding vehicle information keeps the current driving behavior, there is a possibility of collision with the first vehicle 100 or collision with a different second vehicle 101, the second index calculating unit 724 of the lane-change prediction device 1 according to the first embodiment generates an imaginary path on which the second vehicle 101 changes the travel lane in order to avoid the collision and an imaginary path on which the second vehicle 101 decelerates in order to avoid the collision, and calculates the second index on the assumption that the second vehicle 101 travels on each of these imaginary paths. As a result, the second index calculating unit 724 can calculate, as the second index, an index value corresponding to each of the positional relationship between the first vehicle 100 and the second vehicle 101 and the current positional relationship between different second vehicles 101.

In the lane-change prediction device 1 according to the first embodiment, the lane-change prediction unit 725 calculates the weighted average of the first index and the second index at a preset ratio, and the lane-change prediction unit 725 changes the weight of the first index and the weight of the second index in the weighted average to calculate the lane change probability. As a result, the lane-change prediction unit 725 can calculate the lane change probability in which the first index and the second index are reflected at a desired ratio.

In the lane-change prediction device 1 according to the first embodiment, the lane-change prediction unit 725 changes the weight of the first index in the weighted average depending on the time length of the travel lane sequence used for calculating the first index. As a result, the lane-change prediction device 1 can predict a lane change with a low possibility of collision with another vehicle while considering the action intention of the driver of the second vehicle 101.

The lane-change prediction method according to the first embodiment includes: by the travel lane calculating unit 721, calculating, by using the surrounding vehicle information related to the second vehicle 101 present around the first vehicle 100 and the road information related to the road on which the first vehicle 100 travels, the travel lane information indicating the travel lane of the second vehicle 101, and storing the travel lane information in the travel-lane storage unit 722 for each second vehicle 101; by the first index calculating unit 723, calculating the first index that corresponds to the conditional probability of keeping the travel lane of the second vehicle 101 and the conditional probability of changing the travel lane of the second vehicle 101, on the basis of the time-series information related to the travel lane of the second vehicle 101, the time-series information being indicated by the travel lane information stored in the travel-lane storage unit 722; by the second index calculating unit 724, calculating the second index related to the travel lane change of the second vehicle 101, on the basis of the surrounding vehicle information; and by the lane-change prediction unit 725, calculating the lane change probability that the second vehicle 101 changes the travel lane, on the basis of the first index and the second index. The lane change prediction can be performed in consideration of the action intention of the driver of the second vehicle 101 by performing the lane-change prediction method using the first index reflecting the action intention of the driver of the second vehicle 101.

By the program according to the first embodiment being executed by a computer, the computer can function as the lane-change prediction device 1 capable of performing lane change prediction in consideration of the action intention of the driver of the second vehicle 101.

### Second Embodiment

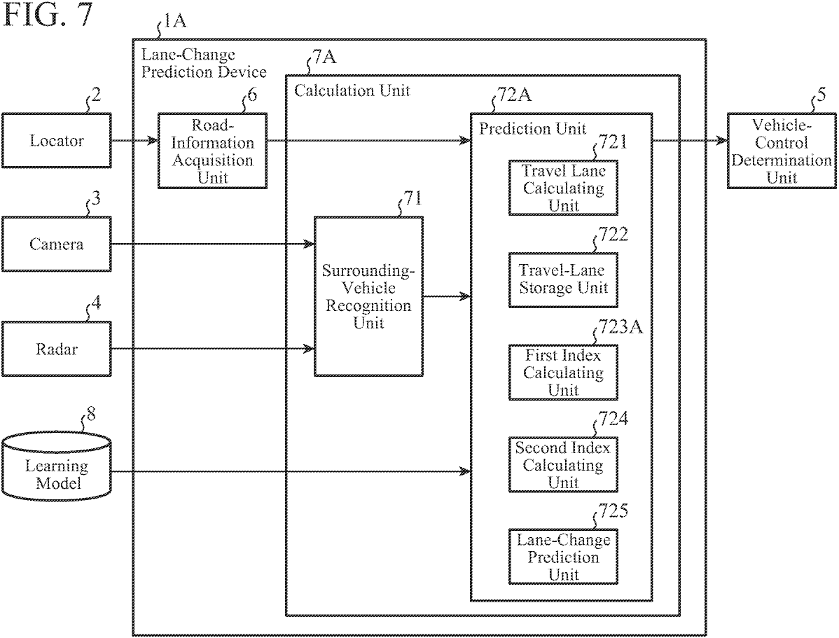

FIG. 7 is a block diagram illustrating a configuration of a lane-change prediction device 1A according to a second embodiment. In FIG. 7, the lane-change prediction device 1A is provided in the first vehicle 100 and predicts the lane change of one or a plurality of second vehicles 101 traveling around the first vehicle 100. The locator 2, the camera 3, and the radar 4 are mounted on the first vehicle 100, and the vehicle-control determination unit 5 is one of functions of an ECU included in the first vehicle 100. Note that the lane-change prediction device 1A may be mounted on the first vehicle, or may be implemented as a function of a server capable of wirelessly communicating with the locator 2, the camera 3, the radar 4, and the vehicle-control determination unit 5 mounted on the first vehicle 100.

A storage device 8 stores a database in which a learning model that outputs a first index of a vehicle when a travel lane sequence of the vehicle is input is registered in association with an object type of the vehicle. In FIG. 7, in order to clarify the storage data of the storage device 8, it is described as “learning model”. The object type of the vehicle is information indicating a vehicle type, and is, for example, a large vehicle, an ordinary vehicle, a motorcycle, or the like. Through learning using a travel lane sequence of a vehicle for each object type as learning data, parameters of the learning model are updated in such a way as to output the first index dependent on the object type.

The lane-change prediction device 1A acquires a learning model corresponding to the object type of the second vehicle 101 from the database stored in the storage device 8, and calculates the first index of the second vehicle 101 using the acquired learning model. Further, the lane-change prediction device 1A calculates a second index of the second vehicle 101 using surrounding vehicle information, and predicts the lane change of the second vehicle 101 using the first index and the second index. The lane-change prediction device 1 according to the first embodiment calculates the first index independent of the object type of the second vehicle 101, but the lane-change prediction device 1A according to the second embodiment calculates the first index dependent on the object type. The lane-change prediction device 1A can thus perform lane change prediction in consideration of the action intention of the driver of the second vehicle 101 for each object type of the second vehicle 101.

The lane-change prediction device 1A includes the road-information acquisition unit 6 and a calculation unit 7A. The calculation unit 7A includes the surrounding-vehicle recognition unit 71 and a prediction unit 72A. The prediction unit 72A predicts the lane change of one or a plurality of second vehicles 101 traveling around the first vehicle 100, and outputs lane-change prediction information on the second vehicle 101 to the vehicle-control determination unit 5.

As illustrated in FIG. 7, the prediction unit 72A includes the travel lane calculating unit 721, the travel-lane storage unit 722, a first index calculating unit 723A, the second index calculating unit 724, and the lane-change prediction unit 725. The first index calculating unit 723A identifies the object type of the second vehicle 101 included in the surrounding vehicle information, acquires the learning model corresponding to the object type of the second vehicle 101 from the database stored in the storage device 8, and calculates the first index using the learning model. For example, when the travel lane sequence of the second vehicle 101 is input, the learning model outputs the first index of the second vehicle 101.

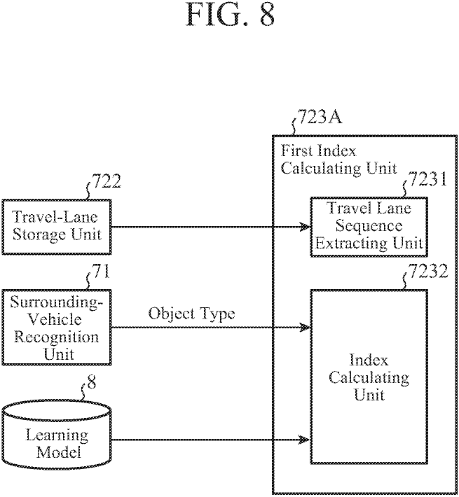

FIG. 8 is a block diagram illustrating a configuration of the first index calculating unit 723A included in the lane-change prediction device 1A. As illustrated in FIG. 8, the first index calculating unit 723A includes a travel lane sequence extracting unit 7231 and an index calculating unit 7232. The travel lane sequence extracting unit 7231 extracts a travel lane sequence of the second vehicle 101 from the past to the present, from the travel lane information stored in the travel-lane storage unit 722. The index calculating unit 7232 determines the object type of the second vehicle 101 from the surrounding vehicle information output by the surrounding-vehicle recognition unit 71, selects the learning model corresponding to the determined object type from the database stored in the storage device 8, and calculates the first index using the selected learning model. As a result, the index calculating unit 7232 can calculate the first index dependent on the object type.

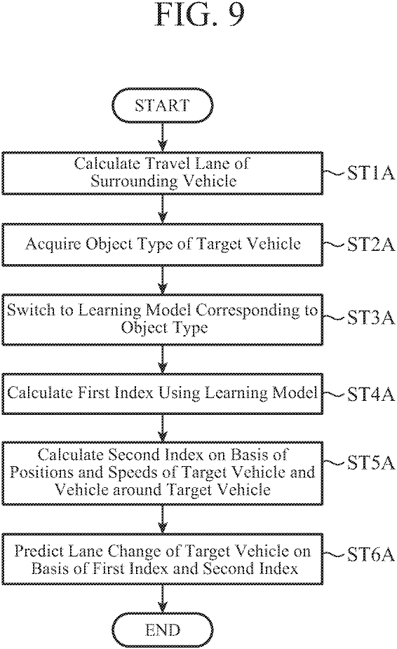

FIG. 9 is a flowchart illustrating a lane-change prediction method according to the second embodiment, and illustrates an operation of the prediction unit 72A. The travel lane calculating unit 721 calculates travel lane information indicating the travel lane of the second vehicle 101 by using the surrounding vehicle information related to the second vehicle 101 present around the first vehicle 100 and the road information related to a road on which the first vehicle 100 travels, and stores the travel lane information in the travel-lane storage unit 722 for each second vehicle 101 (step ST1A).

The first index calculating unit 723A determines the object type of the second vehicle 101 from the surrounding vehicle information output by the surrounding-vehicle recognition unit 71, and selects the learning model corresponding to the determined object type from the database stored in the storage device 8 (step ST2A). The first index calculating unit 723A switches the learning model to be used for calculating the first index to the learning model selected from the database (step ST3A), and calculates the first index using the switched learning model (step ST4A). Here, the first index corresponds to a conditional probability of keeping the travel lane of the second vehicle 101 and a conditional probability of changing the travel lane of the second vehicle 101 which depend on the object type.

For example, it is assumed that a large vehicle tends to hinder the lane change of another vehicle when traveling in a passing lane for a long time, and a rate of changing the lane to the passing lane and overtaking the preceding vehicle, and then returning from the passing lane to the original lane is higher than that of an ordinary vehicle. In this case, it is conceivable that the driver of the second vehicle 101, which is a large vehicle, has a stronger action intention to return from the passing lane to the original lane after overtaking a vehicle in the passing lane than the driver of the ordinary vehicle. Therefore, in the second embodiment, the learning model for the large vehicle is learned in such a way as to output the first index with a higher probability of changing the lane than the probability of keeping the lane as compared with the learning model for the ordinary vehicle.

The second index calculating unit 724 calculates the second index related to the travel lane change or the deceleration of the second vehicle 101 on the basis of the surrounding vehicle information (step ST5A). For example, the second index is an index in which the probability of traveling on an imaginary path with a low possibility of collision with another vehicle among a plurality of possible imaginary paths for the second vehicle 101 is increased. By using the second index, the lane-change prediction device 1A can easily select the path with a low possibility of collision with another vehicle.

Note that the order of the first index calculating process in step ST4A and the second index calculating process in step ST5A is not limited to this order. For example, the first index calculating process and the second index calculating process may be switched, or these processes may be performed simultaneously.

The lane-change prediction unit 725 calculates the lane change probability that the second vehicle 101 changes the travel lane on the basis of the first index and the second index (step ST6A). As a result, the lane-change prediction device 1A can predict a lane change with a low possibility of collision with another vehicle while considering the action intention of the driver of the second vehicle 101 for each object type.

Note that the functions of the travel lane calculating unit 721, the travel-lane storage unit 722, the first index calculating unit 723A, the second index calculating unit 724, and the lane-change prediction unit 725 included in the lane-change prediction device 1A are implemented by a processing circuit. That is, the lane-change prediction device 1A includes a processing circuit for performing the processes from step ST1A to step ST6A illustrated in FIG. 9. The processing circuit may be the processing circuit 202 of dedicated hardware illustrated in FIG. 6A, or may be the processor 203 that executes the program stored in the memory 204 illustrated in FIG. 6B.

As described above, the first index calculating unit 723A of the lane-change prediction device 1A according to the second embodiment acquires the learning model corresponding to the object type of the second vehicle 101 included in the surrounding vehicle information from the database in which the learning model that outputs the first index when the travel lane sequence of the second vehicle 101 is input to the learning model is registered in association with the object type of the second vehicle 101, and calculates the first index using the learning model. As a result, the lane-change prediction device 1A can perform lane change prediction in consideration of the action intention of the driver for each object type of the second vehicle 101.

### Third Embodiment

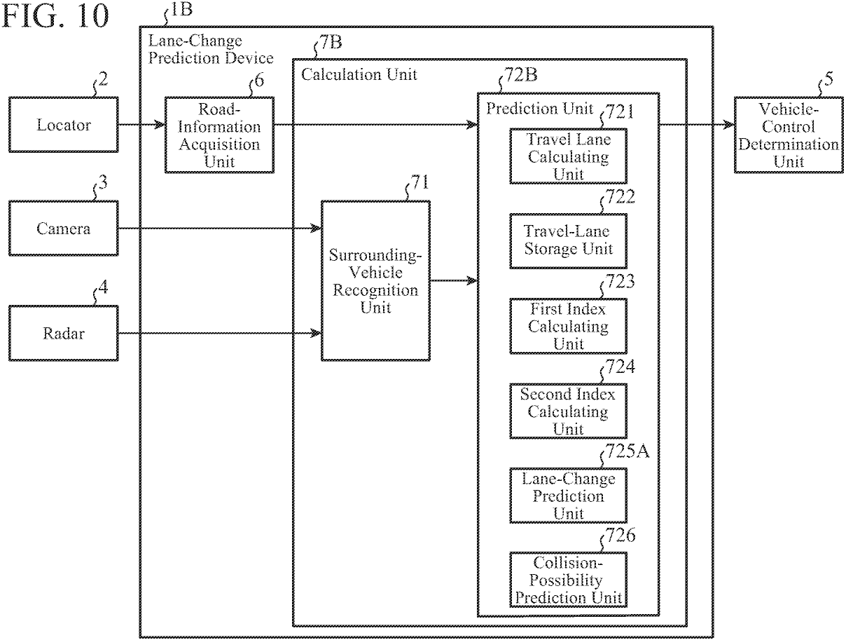

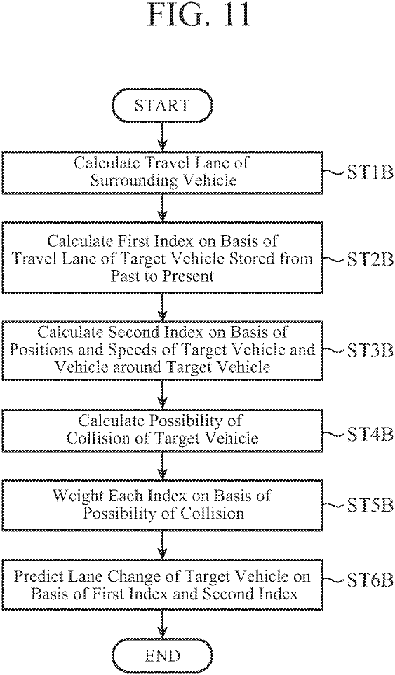

FIG. 10 is a block diagram illustrating a configuration of a lane-change prediction device 1B according to a third embodiment. In FIG. 10, the lane-change prediction device 1B is provided in the first vehicle 100 and predicts the lane change of one or a plurality of second vehicles 101 traveling around the first vehicle 100. The locator 2, the camera 3, and the radar 4 are mounted on the first vehicle 100, and the vehicle-control determination unit 5 is one of functions of an ECU included in the first vehicle 100. Note that the lane-change prediction device 1B may be mounted on the first vehicle, or may be implemented as a function of a server capable of wirelessly communicating with the locator 2, the camera 3, the radar 4, and the vehicle-control determination unit 5 mounted on the first vehicle 100.

The lane change probability is a probability obtained by weighted-averaging a first index and a second index. The lane-change prediction device 1B calculates a value indicating the possibility that the second vehicle 101 collides with another vehicle separately from the first index and the second index, and calculates the lane change probability in which the weights of the first index and the second index are changed on the basis of the value indicating the possibility of collision. As a result, the lane-change prediction device 1B can perform lane change prediction in consideration of the action intention of the driver of the second vehicle 101 depending on the possibility of collision of the second vehicle 101.

The lane-change prediction device 1B includes the road-information acquisition unit 6 and a calculation unit 7B. The calculation unit 7B includes the surrounding-vehicle recognition unit 71 and a prediction unit 72B. The prediction unit 72B predicts the lane change of one or a plurality of second vehicles 101 traveling around the first vehicle 100, and outputs lane-change prediction information on the second vehicle 101 to the vehicle-control determination unit 5.

As illustrated in FIG. 10, the prediction unit 72B includes the travel lane calculating unit 721, the travel-lane storage unit 722, the first index calculating unit 723, the second index calculating unit 724, a lane-change prediction unit 725A, and a collision-possibility prediction unit 726. The lane-change prediction unit 725A calculates the lane change probability, by changing the weights of the first index and the second index in the weighted average depending on the possibility of collision of the second vehicle 101 predicted by the collision-possibility prediction unit 726.

The collision-possibility prediction unit 726 predicts, on the basis of the position and speed of the second vehicle 101 included in the surrounding vehicle information, the possibility of collision that the second vehicle 101 collides with another vehicle in the travel lane and the adjacent lane of the second vehicle 101. For example, by using the surrounding vehicle information, the collision-possibility prediction unit 726 calculates, as a value indicating the possibility of collision, the distance at which the second vehicle 101 approaches another vehicle most when the second vehicle 101 makes a uniformly accelerated linear motion or changes the lane for several seconds from the present to the future. The value indicating the possibility of collision may be Time to Collision (TTC) obtained by dividing the distance between the second vehicle 101 and another vehicle by a relative speed.

FIG. 11 is a flowchart illustrating a lane-change prediction method according to the third embodiment, and illustrates an operation of the prediction unit 72B. The travel lane calculating unit 721 calculates travel lane information indicating the travel lane of the second vehicle 101 by using the surrounding vehicle information related to the second vehicle 101 present around the first vehicle 100 and the road information related to a road on which the first vehicle 100 travels, and stores the travel lane information in the travel-lane storage unit 722 for each second vehicle 101 (step ST1B).

The first index calculating unit 723 calculates the first index that corresponds to the conditional probability of keeping the travel lane of the second vehicle 101 and the conditional probability of changing the travel lane of the second vehicle 101, on the basis of the travel lane sequence of the second vehicle 101 indicated by the travel lane information (step ST2B). The second index calculating unit 724 calculates the second index related to the travel lane change or the deceleration of the second vehicle 101 on the basis of the surrounding vehicle information (step ST3B).

Note that the order of the first index calculating process in step ST2B and the second index calculating process in step ST3B is not limited to this order. For example, the first index calculating process and the second index calculating process may be switched, or these processes may be performed simultaneously.

Next, the collision-possibility prediction unit 726 predicts, by using the surrounding vehicle information, the possibility of collision that the second vehicle 101 collides with another vehicle in the travel lane and the adjacent lane of the second vehicle 101 (step ST4B). Information related to the possibility of collision of the second vehicle 101 calculated by the collision-possibility prediction unit 726 is output to the lane-change prediction unit 725A.

The lane-change prediction unit 725A changes the weight of the first index and the weight of the second index in the weighted average on the basis of the information related to the possibility of collision of the second vehicle 101 (step ST5B). For example, the lane-change prediction unit 725A reduces the weight of the first index in a case where the possibility of collision with another vehicle is high in the area of the lane change destination of the second vehicle 101. The lane-change prediction unit 725A then calculates the lane change probability that the second vehicle 101 changes the travel lane, by weighted-averaging the first index and the second index using the weights determined in step ST5B (step ST6B).

As a result, the lane-change prediction device 1B can perform lane change prediction in consideration of the action intention of the driver of the second vehicle 101 depending on the possibility of collision of the second vehicle 101.

Note that the second index is an index obtained in consideration of the distance at which the second vehicle 101 and another vehicle come closest to each other, and thus can be regarded as a value indicating the possibility of collision of the second vehicle 101. Therefore, the lane-change prediction unit 725A may change the weight of the first index and the weight of the second index in the weighted average by using the second index as the value indicating the possibility of collision of the second vehicle 101.

For example, in a case where the value of the second index is larger than a threshold, the weight of the first index is reduced or the weight of the second index is increased.

Note that the functions of the travel lane calculating unit 721, the travel-lane storage unit 722, the first index calculating unit 723, the second index calculating unit 724, the lane-change prediction unit 725A, and the collision-possibility prediction unit 726 included in the lane-change prediction device 1B are implemented by a processing circuit. That is, the lane-change prediction device 1B includes a processing circuit for performing the processes from step ST1B to step ST6B illustrated in FIG. 11. The processing circuit may be the processing circuit 202 of dedicated hardware illustrated in FIG. 6A, or may be the processor 203 that executes the program stored in the memory 204 illustrated in FIG. 6B.

As described above, the lane-change prediction device 1B according to the third embodiment includes the collision-possibility prediction unit 726 that predicts, on the basis of the position and speed of the second vehicle 101 included in the surrounding vehicle information, the possibility of collision that the second vehicle 101 collides with another vehicle in the travel lane and the adjacent lane of the second vehicle 101. The lane-change prediction unit 725A changes the weight of the first index and the weight of the second index in the weighted average on the basis of the possibility of collision predicted by the collision-possibility prediction unit 726. As a result, the lane-change prediction device 1B can perform lane change prediction in consideration of the action intention of the driver of the second vehicle 101 depending on the possibility of collision of the second vehicle 101.

Note that it is possible to combine the embodiments, modify any component of each embodiment, or omit any component of each embodiment.

### REFERENCE SIGNS LIST

1, 1A, 1B: lane-change prediction device, 2: locator, 3: camera, 4: radar, 5: vehicle-control determination unit, 6: road-information acquisition unit, 7, 7A, 7B: calculation unit, 8: storage device, 71: surrounding-vehicle recognition unit, 72, 72A, 72B: prediction unit, 100: first vehicle, 101, 101A, 101B: second vehicle, 200: input interface, 201: output interface, 202: processing circuit, 203: processor, 204: memory, 721: travel lane calculating unit, 722: travel-lane storage unit, 723, 723A: first index calculating unit, 724: second index calculating unit, 725, 725A: lane-change prediction unit, 726: collision-possibility prediction unit, 7231: travel lane sequence extracting unit, 7232: index calculating unit

1. A lane-change prediction device comprising:
processing circuitry
to calculate, by using road information related to a road on which a first vehicle travels and surrounding vehicle information related to at least one second vehicle present around the first vehicle, travel lane information indicating a travel lane of the second vehicle;
to store, for each of the at least one second vehicle, the travel lane information;
to calculate a first index that corresponds to a conditional probability of keeping the travel lane of the second vehicle and a conditional probability of changing the travel lane of the second vehicle, on a basis of time-series information related to the travel lane of the second vehicle, the time-series information being indicated by the travel lane information stored;
to calculate a second index related to a travel lane change or deceleration of the second vehicle, on a basis of the surrounding vehicle information; and
to calculate a lane change probability that the second vehicle changes the travel lane, on a basis of the first index and the second index.

2. The lane-change prediction device according to claim 1, wherein
the processing circuitry acquires a travel lane sequence of the second vehicle in a preset period from past to present, and calculates the first index using the travel lane sequence acquired, the travel lane sequence being indicated by the travel lane information stored.

3. The lane-change prediction device according to claim 2, wherein
the processing circuitry acquires a learning model corresponding to an object type of the second vehicle included in the surrounding vehicle information from a database in which the learning model that outputs the first index when the travel lane sequence of the second vehicle is input to the learning model is registered in association with the object type of the second vehicle, and calculates the first index using the learning model acquired.

4. The lane-change prediction device according to claim 1, wherein
in a case where assuming that the second vehicle indicated by the surrounding vehicle information keeps a current driving behavior, there is a possibility of collision with the first vehicle or collision with a different second vehicle, the processing circuitry generates a first imaginary path on which the second vehicle changes the travel lane in order to avoid the collision and a second imaginary path on which the second vehicle decelerates in order to avoid the collision, and calculates the second index on an assumption that the second vehicle travels on each of the first imaginary path and the second imaginary path.

5. The lane-change prediction device according to claim 1, wherein
the processing circuitry calculates a weighted average of the first index and the second index at a preset ratio, and
the processing circuitry changes a weight of the first index and a weight of the second index in the weighted average to calculate the lane change probability.

6. The lane-change prediction device according to claim 5, wherein
the processing circuitry predicts, on a basis of a position and a speed of the second vehicle included in the surrounding vehicle information, a possibility of collision that the second vehicle collides with another vehicle in the travel lane and an adjacent lane of the second vehicle, and
the processing circuitry changes the weight of the first index and the weight of the second index in the weighted average on a basis of the possibility of collision predicted.

7. The lane-change prediction device according to claim 5, wherein
the processing circuitry changes the weight of the first index in the weighted average depending on a time length of a travel lane sequence used for calculating the first index.

8. A lane-change prediction method comprising:
calculating, by using road information related to a road on which a first vehicle travels and surrounding vehicle information related to at least one second vehicle present around the first vehicle, travel lane information indicating a travel lane of the second vehicle, and storing, for each of the at least one second vehicle, the travel lane information;
calculating a first index that corresponds to a conditional probability of keeping the travel lane of the second vehicle and a conditional probability of changing the travel lane of the second vehicle, on a basis of time-series information related to the travel lane of the second vehicle, the time-series information being indicated by the travel lane information stored;
calculating a second index related to a travel lane change or deceleration of the second vehicle, on a basis of the surrounding vehicle information; and
calculating a lane change probability that the second vehicle changes the travel lane, on a basis of the first index and the second index.

9. A non-transitory computer readable recording medium having stored thereon a program to be executed on a computer, the program causing the computer to function as the lane-change prediction device according to claim 1.
